(19) United States
(12) Patent Application Publication
(10) Pub. No.: US 2016/0117631 A1
(43) Pub. Date: Apr. 28, 2016

(54) ORPHANED ITEM IDENTIFICATION

(71) Applicant: Honeywell International Inc., Morristown, NJ (US)

(72) Inventors: Scott McCloskey, Minneapolis, MN (US); Kwong Wing Au, Bloomington, MN (US); Ryan Andrew Lloyd, Burnsville, MN (US)

(21) Appl. No.: 14/693,676

(22) Filed: Apr. 22, 2015

Related U.S. Application Data
(63) Continuation-in-part of application No. 14/520,838, filed on Oct. 22, 2014.

(51) Int. Cl. G06Q 10/08; G06F 17/30

(52) U.S. Cl. CPC G06Q 10/083; G06F 17/3056; G06F 17/30554

(57) ABSTRACT

A system receives data associated with an orphaned item, compares the data associated with the orphaned item to data in a database, generates a list of candidate items based on the comparison, and identifies the orphaned item as a function of the list of candidate items.

### RELATED APPLICATIONS

This application is a continuation-in-part of, and claims priority to, U.S. application Ser. No. 14/520,838, entitled Orphaned Package Identification, filed on Oct. 22, 2014, the content of which is incorporated herein by reference in its entirety.

### TECHNICAL FIELD

The present disclosure relates to a system and method for identifying orphaned packages, orphaned luggage, and other orphaned items.

### BACKGROUND

In the transportation and logistics market, reliable and on-time delivery of packages and parcels is important for both the financial and reputational stability of a company, especially for organizations such as United Parcel Service (UPS), Federal Express, and DHL. However, the high volume of packages passing through transit points inevitably leads to cases in which packages are lost. This results in reduced customer satisfaction and perhaps financial penalties. Because packages are tracked using barcodes and/or shipping labels that are affixed to the package, failure cases arise when those labels are inadvertently removed or are damaged beyond recognition. Such parcels, where shipping labels are either removed or unrecognizable, can be referred to as “orphaned” packages. A package that misses a scan at a transit point and ends up at an unexpected location, even if it has a label, may also be deemed an orphaned package. Lost items can also be a problem in other industries and businesses, such as lost pieces of luggage in the airline and other transportation industries.

### BRIEF DESCRIPTION OF THE DRAWINGS

FIG. 1 is a block diagram of a system for collecting data on packages that are provided to a shipping company by customers for shipping.

FIG. 2 is a block diagram of a system for collecting data from an orphaned package.

FIG. 3 is a block diagram of an example system for identifying packages in a package shipping facility for placement on a list of candidate packages.

FIG. 4 is block diagram illustrating features and operations of a system that identifies orphaned packages.

FIG. 5 is block diagram illustrating features and operations of another system that identifies orphaned packages.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, electrical, and optical changes may be made without departing from the scope of the present invention. The following description of example embodiments is, therefore, not to be taken in a limited sense, and the scope of the present invention is defined by the appended claims.

The inventors of the current disclosure have had discussions with one or more shipping companies, and the inventors have been informed by the shipping companies that there is a commercial need for a system which identifies orphaned packages.

In an embodiment, a system uses cameras and measuring tools to determine identifying characteristics of an orphaned package, and compares these characteristics to imagery and/or waybill information (size, weight, etc.) of other packages in the company's database. Because many parcels are nearly identical (e.g., brown cardboard in standard sizes), it is not expected that these identifiers will produce a unique determination of the orphaned package's identity. Instead, these characteristics are used to generate a list of candidate packages. The list of candidate packages includes the true parcel (i.e., the orphaned package because it is in the company's database) along with many other parcels. The key to unique identification of the orphaned package is that the other parcels on the candidate list are not orphaned. The other parcels are scanned after the orphaned package is enrolled onto the orphan list—either on a conveyor belt as the packages move through the package distribution facility or as the package goes out of the facility. In either case, non-orphaned packages are scanned into the system at least once by the end of a shift (package distribution facilities typically operate at night, so the end of the shift is in the morning). The system eliminates parcels from the list of candidate packages as they are subsequently scanned, and by the end of the shift, the true identity of the orphaned package should exist on a short list of packages that never left the facility.

In an embodiment, the system includes a camera to record visual features of the orphaned package, along with measuring devices such as a scale (for weight) and range sensors and/or tape measures (for size and shape). Imagery from the camera is used to compute visual features (e.g., using scale invariant feature transform (SIFT) or speeded up robust features (SURF)), which should be invariant to affine transformations. Tape, labels, writing, and creases bear edges that form a signature for each face of a package. Descriptors, such as shape contexts, characterize the edge information. Representations of these features, along with weight and size information, are combined into a feature vector. That feature vector is used with a discriminative hash function to determine a candidate set of packages which have been checked into the facility. The system has access to the shipping company's database, presumed to contain (at least) size and weight information of packages, and containing imagery of the package.

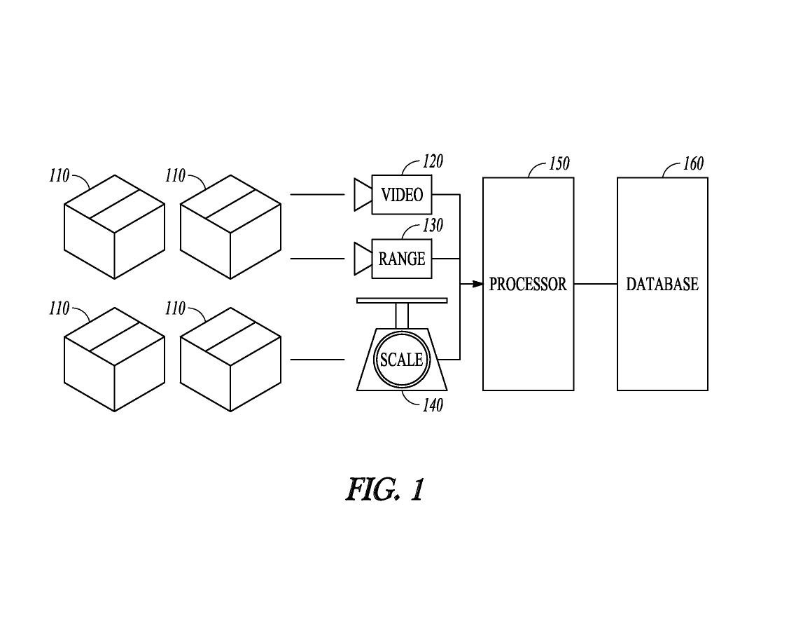

An example embodiment of a system to identify orphaned packages in a package shipping facility is illustrated in FIGS. 1, 2, 3, 4, and 5. Referring to FIG. 1, when a package is brought to a package shipping company by a customer, information is gathered about the package, the customer, and the source and destination of the package shipment. Specifically, data are collected for all packages 110 that come into a shipping facility such as via a video sensing device 120, a range sensing device 130 (or a 3D camera), and/or a weight scale 140. The video sensing device 120, range sensing device 130, and weight scale 140 are coupled to a processor 150, which processes the package data and stores the package data into a package database 160. Consequently, a shipping company has a package database 160 that includes data on every package 110 that the company is shipping.

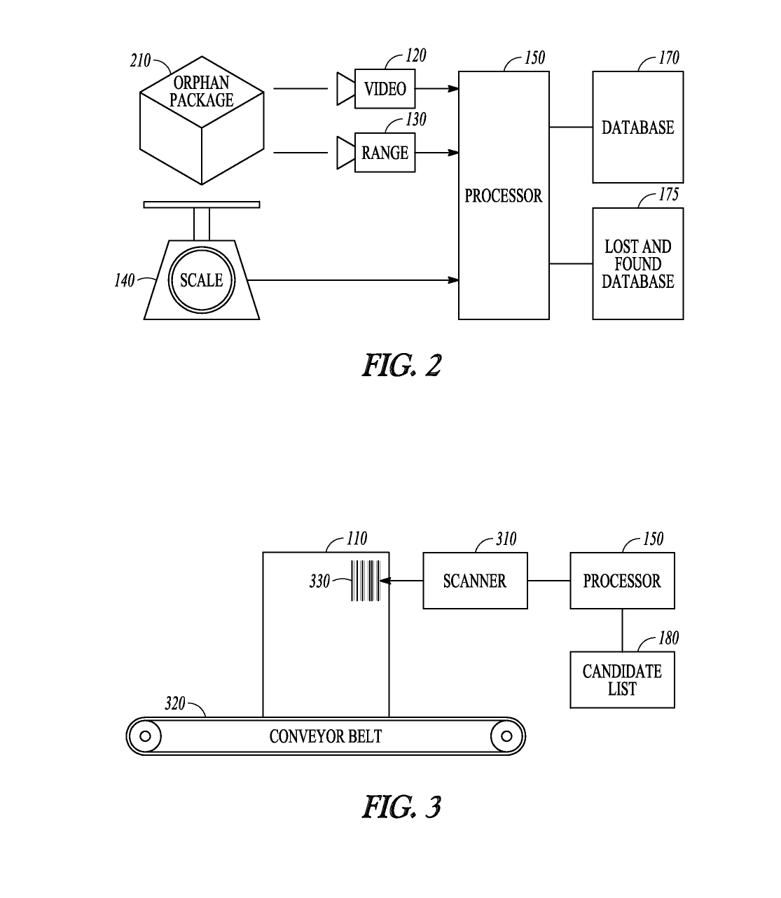

As noted above, at times a package will become orphaned in the shipping facility because, for example, the identifying information on the package (names, addresses, bar code, etc.) becomes damaged or destroyed. In such a case, data relating to the orphaned package must be collected. Referring to FIG. 2, an orphaned package 210 can be weighed on a scale 140, video data collected from the orphaned package by video sensing device 120, and/or range data collected on the orphaned package via the range sensing device 130. The processor 150 can use this range data to generate the dimensions of the package. A simple tape measure could also be used to obtain the size and shape of the package. The scale 140, video sensing device 120, and range sensing device 130 are connected to computer processor 150, which stores the orphaned package data into a database 170. If after a particular period of time, for example a day or a particular work shift, an orphaned package is not identified, data relating to that orphaned package is stored in a lost and found database 175.

The orphaned package data stored in database 170 are compared to the package data in database 160, which contains the package data for all other packages in the shipping facility or distribution center. If a package 110 in the database 160 is similar enough to the data of the orphaned package 210, the data for that package is placed on a candidate list 180.

After the creation of the candidate list, all other packages are identified at some point in the distribution facility as those other packages travel through the distribution facility. For example, as packages move through a particular section of the shipping facility, such as on a conveyor belt 320 as illustrated in FIG. 3, a scanner 310 is used to scan a bar code 330 on the packages 110. The scanner 310 is coupled to a computer processor 150, which compares the bar code data of the package on the conveyor belt to the package data of the packages on the candidate list 180. If the scanned package is on the candidate list, then of course this package cannot be the orphaned package, and this particular package is then removed from the candidate list. A video-based approach can also be used for package identification. At the end or towards the end of a shift, all packages that are not orphaned will have been identified, and if they were candidate packages, will have been removed from the candidate list. If the candidate list has just one package remaining, this package must be the orphaned package, and the orphaned package can then be re-labeled and shipped to its proper destination. If the candidate list has a few packages remaining, further investigation of those packages can identify the orphaned package.

In an embodiment, the system includes a plurality of video sensing devices. The plurality of video sensing devices is configured to track packages as the packages travel through a package distribution facility. The data captured by the plurality of video sensing devices can further be used to identify orphaned packages.

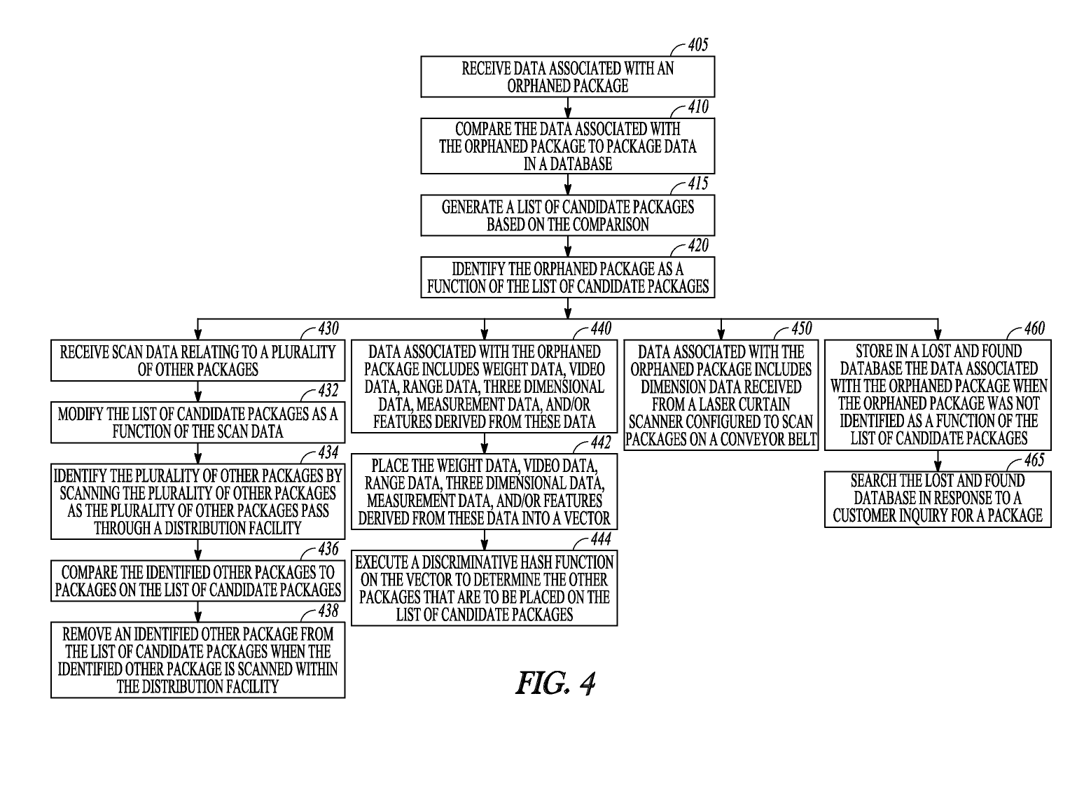

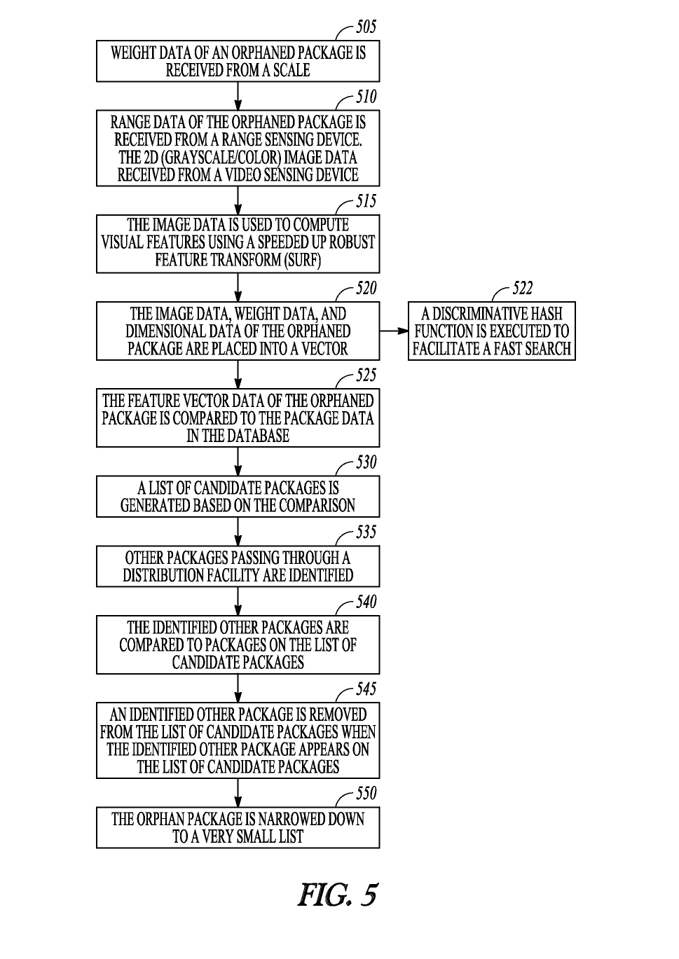

FIGS. 4 and 5 are block diagrams illustrating operations and features of processes and systems for identifying orphaned packages. FIGS. 4 and 5 include a number of process blocks 405-465 and 505-550. Though arranged substantially serially in the example of FIGS. 4 and 5, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring first to FIG. 4, at 405, a system receives data associated with an orphaned package. At 410, the system compares the data associated with the orphaned package to package data in a database. At 415, the system generates a list of candidate packages based on the comparison, and at 420, the system identifies the orphaned package as a function of the list of candidate packages.

At 430, the system receives scan data relating to a plurality of other packages, and at 432, the system modifies the list of candidate packages as a function of the scan data. At 434, the system identifies the plurality of other packages by scanning the plurality of other packages as the plurality of other packages passes through a distribution facility. At 436, the system compares the identified other packages to packages on the list of candidate packages, and at 438, the system removes an identified other package from the list of candidate packages when the identified other package is scanned within the distribution facility.

Block 440 indicates that the data associated with the orphaned package include weight data, video data, range data, three dimensional data, measurement data, and/or features derived from these data. At 442, the system places the weight data, video data, range data, three dimensional data, measurement data, and/or features derived from these data into a vector, and at 444, the system executes a discriminative hash function on the vector to determine the other packages that are to be placed on the list of candidate packages.

Block 450 indicates that the data associated with the orphaned package include dimension data received from a laser curtain scanner configured to scan packages on a conveyor belt.

At 460, the system stores in a lost and found database the data associated with the orphaned package when the orphaned package was not identified as a function of the list of candidate packages. At 465, the system searches the lost and found database in response to a customer inquiry for a package.

Referring now to FIG. 5, at 505, weight data of an orphaned package is received from a scale. At 510, range data of the orphaned package is received from a range sensing device. The range data can be used to generate the dimensions of the package. Also, two dimensional image data (grayscale/color) of the orphaned package can be received from a video sensing device. At 515, the image data are used to compute visual features, e.g., using a scale invariant feature transform (SIFT) or a speeded up robust feature transform (SURF). At 520, the image data, weight data, and range of the orphaned package are placed into a feature vector, and at 525, a similarity metric is computed by comparison of the vectors between an orphaned package and the package data in the database to determine the other packages that are to be placed on the candidate list. At 522 a discriminative hash function is executed to facilitate a fast search. At 530, a list of candidate packages is generated based on the comparison.

At 535, other packages passing through a distribution facility are identified. At 540, the identified other packages are compared to packages on the list of candidate packages. At 545, an identified other package is removed from the list of candidate packages when the identified other package appears on the list of candidate packages. At 550, the orphan package is narrowed down to a very small list when only a few packages remain on the list of candidate packages. In some cases, the orphaned package may be the only package remaining on the candidate list.

In another embodiment, in a manner similar to the embodiments of FIGS. 4 and 5, a system identifies orphaned items in an environment such as orphaned pieces of luggage in an airport or other travel environment. For example, when a passenger checks in his or her luggage at an airport, the airport or airline can gather data on the piece of luggage similar to the data gathered by a package shipping company on a package (i.e., size, shape, and weight). The airport or airline can gather additional information on luggage such as the brand of the luggage, the color of the luggage, and the type of the luggage (e.g., duffle bag, roller suitcase, golf bag, ski bag, and pet carrier). The piece of luggage can be tagged with bar code identification, and the information on the luggage entered into a database of luggage similar to the package database 160. Once tagged with an identifying bar code, the luggage can be scanned as it is placed onto a conveyor belt, into the airplane, taken off the airplane, and loaded onto a conveyor belt at the destination airport. Other scanning points could be implemented depending on the airline and/or the airport. If a particular piece of luggage becomes orphaned, its physical description data are compared to other pieces of luggage in the data base 160, and a candidate list of pieces of luggage is identified similar to the candidate list 180 for packages. As the non-orphaned candidate pieces of luggage move through the system, they are removed from the candidate list once they are scanned (since at that point they cannot be the orphaned piece of luggage). As luggage travels through the system, the candidate list is reduced to one or a few pieces of luggage, thereby aiding in the identification of the orphaned piece of luggage.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
a computer processor; and
a database coupled to the computer processor, the database comprising data relating to items;
wherein the computer processor is operable to:
receive data associated with an orphaned item;
compare the data associated with the orphaned item to the data in a database;
generate a list of candidate items based on the comparison; and
identify the orphaned item as a function of the list of candidate items.

2. The system of claim 1, wherein the computer processor is operable to:
receive scan data relating to a plurality of other items; and
modify the list of candidate items as a function of the scan data.

3. The system of claim 2, wherein the computer processor is operable to:
identify the plurality of other items by receiving notifications that the plurality of other items have been scanned in a facility;
compare the identified other items to items on the list of candidate items; and
remove an identified other item from the list of candidate items when the identified other item is scanned within the facility.

4. The system of claim 3, wherein the items, orphaned item, and candidate items comprise luggage.

5. The system of claim 1, wherein the data associated with the orphaned item comprise one or more of weight data, video data, range data, three dimensional data, measurement data, color data, brand data, type data, and features derived from these data.

6. The system of claim 5, wherein the computer processor is operable to:
place the weight data, video data, range data, three dimensional data, measurement data, color data, brand data, type data, and features derived from these data into a vector; and
execute a discriminative hash function on the vector to facilitate a fast search and comparisons on the list of candidate items.

7. The system of claim 1, wherein the data associated with the orphaned item comprise dimension data received from a laser curtain scanner configured to scan items on a conveyor belt.

8. The system of claim 1, wherein the computer processor is operable to:
store in a lost and found database the data associated with the orphaned item when the orphaned item was not identified as a function of the list of candidate items; and
search the lost and found database in response to a customer inquiry for an item.

9. The system of claim 1, comprising:
a video sensing device operable to receive image data of the orphaned item;
a weighing scale operable to receive weight data of the orphaned item; and
a range sensing device operable to receive range data of the orphaned item;
wherein the computer processor is operable to:
generate one or more dimensions of the orphaned item using the range data;
compare the image data, the weight data, and dimensions of the orphaned item to the data in the database;
generate the list of candidate items based on the comparison;
identify other items passing through a facility;
compare the identified other items to items on the list of candidate items;
remove an identified other item from the list of candidate items when the identified other item appears on the list of candidate items; and
identify the orphaned item as a function of one or more items remaining on the list of candidate items.

10. The system of claim 1, comprising a plurality of video sensing devices, the plurality of video sensing devices configured to track items as the items travel through a facility.

11. A system comprising:
a computer processor;
a database coupled to the computer processor, the database comprising luggage data;
a weighing scale coupled to the computer processor; and
a range device coupled to the computer processor;
wherein the computer processor is operable to:
receive weight data of orphaned luggage from the weighing scale;
receive range data of the orphaned luggage from the range sensing device;
generate a feature vector describing the orphaned luggage, the feature vector comprising one or more of weight data, range data, color data, brand data, type data, and features derived from these data of the orphaned luggage;
compare the feature vector of the orphaned luggage to the luggage data in the database;
generate a list of candidate luggage based on the comparison;
identify other luggage passing through a facility;
compare the identified other luggage to luggage on the list of candidate luggage;
remove an identified other luggage from the list of candidate luggage when the identified other luggage appears on the list of candidate luggage; and
identify the orphaned luggage as a function of luggage remaining on the list of candidate luggage.

12. The system of claim 11, comprising a plurality of video sensing devices, the plurality of video sensing devices configured to track luggage as the luggage travels through the facility.

13. The system of claim 11, wherein the computer processor is operable to execute a discriminative hash function on the feature vector to facilitate a fast search and comparisons on the list of candidate luggage.

14. A process comprising:
receiving data associated with orphaned luggage;
comparing the data associated with the orphaned luggage to luggage data in a database;
generating a list of candidate luggage based on the comparison; and
identifying the orphaned luggage as a function of the list of candidate luggage.

15. The process of claim 14, comprising:
receiving scan data relating to a plurality of other luggage; and
modifying the list of candidate luggage as a function of the scan data.

16. The process of claim 15, comprising:
identifying the plurality of other luggage by receiving notifications that the plurality of other luggage has been scanned in a facility;
comparing the identified other luggage to luggage on the list of candidate luggage; and
removing an identified other luggage from the list of candidate luggage when the identified other luggage is scanned within the facility.

17. The process of claim 14, wherein the data associated with the orphaned luggage comprises one or more of weight data, video data, range data, three dimensional data, measurement data, color data, brand data, type data, and features derived from these data.

18. The process of claim 17, comprising:
placing the weight data, video data, range data, three dimensional data, measurement data, color data, brand data, type data, and features derived from these data into a vector; and
executing a discriminative hash function on the vector to facilitate a fast search and comparisons on the list of candidate luggage.

19. The process of claim 14, comprising storing in a lost and found database the data associated with the orphaned luggage when the orphaned luggage was not identified as a function of the list of candidate luggage.

20. The process of claim 19, comprising searching the lost and found database in response to a customer inquiry for luggage.
